(19) United States
(12) Patent Application Publication
(10) Pub. No.: US 2022/0133097 A1
(43) Pub. Date: May 5, 2022

(54) TOWEL WARMING DEVICE AND METHODS

(71) Applicant: Barry HERRSCHER, American Fork, UT (US)

(72) Inventor: Barry HERRSCHER, American Fork, UT (US)

(21) Appl. No.: 17/520,366

(22) Filed: Nov. 5, 2021

Related U.S. Application Data
(60) Provisional application No. 63/110,080, filed on Nov. 5, 2020.

(51) Int. Cl. A47K 10/06; A47K 10/02; H05B 1/02

(52) U.S. Cl. CPC A47K 10/06; H05B 1/0272; A47K 10/025

(57) ABSTRACT

A towel warming device and related methods for warming towels includes a housing defining a cavity, the housing configured to be mounted in a wall of the bathroom or shower stall, the cavity being sized to store at least one towel, at least one heating element operable to increase a temperature within the cavity to warm the at least one towel, a door operable to control access to the cavity, and a temperature control device operable to control the at least one heating element.

### CROSS-REFERENCE TO RELATED APPLICATION

This application is a U.S. Non-Provisional Application claiming the benefit of and priority to U.S. Provisional Application No. 63/110,080, filed Nov. 5, 2020, entitled TOWEL WARMING DEVICE AND METHODS, the disclosure of which is incorporated herein by reference in its entirety.

### TECHNICAL FIELD

The present disclosure relates generally to towel warming devices, and more particularly to towel warming devices and related methods of warming towels in a shower or bath environment.

### BACKGROUND

Some efforts have been made to enhance living comfort and quality of life for people in their later years of life. As individuals age, the desire for maintaining good hygiene and personal cleanliness often is diminished due to the discomfort and required energy associated with such activities. For many people, simple hygiene tasks such as bathing or showering may be extremely uncomfortable, particularly when an individual's blood flow slows, making his/her more susceptible to becoming cold and having difficulty warming up after getting cold. The discomfort associated with being cold is enough to prevent some individuals from engaging in bathing/showering on a regular (e.g., daily) basis.

Opportunities exist for improving the bathing or showering experience by reducing the impact of becoming cold upon completion of such activities.

### SUMMARY

One aspect of the present disclosure is directed to a towel warming device that facilitates access to a warm, dry towel from within a shower stall, bathtub, or other area of a bathroom while the person is within the shower or bathtub area. The towel warming device may include a towel storage box or cavity wherein the towels are stored and heated prior to or during the bathing/showering activity by an individual. The towel warming device may include an easy to open door that controls access to the warmed towels. The door may be transparent so that the user can identify whether towels are stored within the cavity prior to opening the door. The towel warming device may include lighting, user interface, or other communication features that indicate whether the towel stored therein is warm, dry, or heated to a particular temperature. In general, the towel warming device provides access to a warm towel that can be used to dry off the user without having to open the shower door, pull back the shower curtain in a bathtub area, or otherwise expose the user to cold air and/or cooling off of the wet body that may otherwise occur if the towel is stored in another location or the towel is not warm for use.

The towel warming device is designed to be accessible from inside of a shower or bathtub area when the shower curtain is drawn closed. The towel warming device may be designed to be mounted in the wall during construction of the shower or bathtub area. Alternatively, the towel warming device can be retrofit into the wall of the shower or bathtub area, or at other locations in a bathroom. The portion of the towel warming device that is exposed within the shower or bathtub area (i.e., the front side of the device) may be flush mounted with the wall surface and/or may include a bezel or other feature that provides a smooth transition from the wall surface to the door and other features of the towel warming device. In one example, the towel warming device includes a rubber molding outlining the outside edge of a box that defines a front surface of the towel warming device. A glass door may be inset within the rubber molding, and the interface between the glass door and molding provides a waterproof seal to maintain the interior of the box and the towels stored therein in a dry state.

One aspect of the present disclosure relates to a towel warming device for use in a bathroom or shower stall. The device includes a housing defining a cavity, the housing configured to be mounted in a wall of the bathroom or shower stall, the cavity being sized to store at least one towel, at least one heating element operable to increase a temperature within the cavity to warm the at least one towel, a door operable to control access to the cavity, and a temperature control device operable to control the at least one heating element.

The cavity may be sized to store at least two towels. The at least one heating element may include separate heating elements positioned at on at least two walls of the housing that define the cavity. The at least one heating element may include a module configured to be removably mounted in the cavity. The module may include at least four walls. Each of the at least four walls may include a portion of a resistive heating member. The at least one heating element may be powered with AC power and is configured to be wired to electrical wiring of the bathroom or building that houses the shower stall. The temperature control device is wirelessly connected to the at least one heating element. The towel warming device may further include at least one temperature sensor to detect the temperature within the cavity. The temperature control device may include a user interface at least one user selectable option for controlling one or more functions of the towel warming device. The towel warming device may also include a light source operable to provide light within the cavity. The door may include a transparent portion. The housing may include a flexible bezel configured to provide a water-tight connection between the housing and the wall. The towel warming device may include one or more sensors to generate a sensor signal in response to detecting at least one of opening a door of the shower stall or turning on a shower faucet, the temperature control device being operable to turn on the at least one heating element in response to the sensor signal.

A further aspect of the present disclosure relates to a method of warming a towel that includes providing a towel warming device mounted in a wall of a bathroom or shower stall, the towel warming device including a cavity, at least one heating element operable to increase a temperature within the cavity, a door operable to control access to the cavity, and a controller, receiving at least one towel within the cavity, operating the controller to turn on the at least one heating element to increase a temperature within the cavity, and automatically turning off the at least one heating element with the controller after at least one of detecting a threshold temperature of the towel, detecting a threshold temperature of the cavity, or a predetermined time period.

The method may further include illuminating the cavity with at least one light generating device. The method may include receiving at least one user input at a user interface, the at least one user input providing operation of the controller. The method may include detecting at least one of shower door operation or a shower faucet operation, and operating the controller based on the detecting. The method may include detecting the door in a closed position prior to operating the controller to turn on the at least one heating element. The method may include wirelessly controlling the at least one heating element.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the embodiments may be realized by reference to the following drawings. In the appended figures, similar components or features may have the same reference label.

FIG. 1 is a perspective view of an example towel warming device in accordance with the present disclosure.

FIG. 2 is a perspective view of the towel warming device shown in FIG. 1 with the door open.

FIG. 3 is a front view of the towel warming device shown in FIG. 1.

FIG. 4 is a perspective view of a heating assembly of the towel warming device shown in FIG. 1.

FIG. 5 is a left side view of the heating assembly shown in FIG. 4.

FIG. 6 is a top view of the heating assembly shown in FIG. 4.

FIG. 7 is right side view of the heating assembly shown in FIG. 4.

FIG. 8 is a cross-sectional view of towel warming device shown in FIG. 1 with the heating assembly partially inserted into a cavity of the housing.

FIG. 9 is a cross-sectional view of a shower with the towel warming device of FIG. 1 mounted in a wall thereof.

FIG. 10 is a schematic view of a system implementing various electronic aspects of the present disclosure.

FIG. 11 is a flow diagram showing steps of an example method in accordance with the present disclosure.

While the embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that the methods may be performed in an order different than that described, and that various steps may be added, omitted or combined. Also, aspects and elements described with respect to certain embodiments may be combined in various other embodiments. It should also be appreciated that the following systems, methods, and devices may individually or collectively be components of a larger system, wherein other procedures may take precedence over or otherwise modify their application.

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein without departing from the spirit and scope of the disclosure. Thus, the detailed description herein is presented for purposes of illustration only and not of limitation.

In various embodiments, with reference to the accompanying figures, the present disclosure generally provides a towel warming device and related methods of warming towels. The warmed towels are intended to be accessed from the inside of a shower or bathtub area. The towel warming device may be mounted in the wall of the shower or bathtub area, such as at an end or side of the shower that is opposite the shower head or opposite the faucet of a bathtub. In general, the towel warming device is intended to be accessible to a user positioned within the shower or bathtub area without having to open the shower door or pull back the shower curtain of the bathtub area (i.e., while positioned within the tub or shower).

In at least one example, the towel warming device includes a housing that is sized to fit between the wall studs, which are typically spaced apart at 16 inch centers. The housing may have any desirable height and/or depth, but preferably is sized to hold at least one towel therein. In one example, the interior of the housing is tall with a narrow depth such that a towel can be hung within the cavity of the housing and the housing does not have to protrude beyond the thickness of the wall or much beyond the thickness of the wall (i.e., into the space of the shower or in an opposite direction beyond a back side of the shower wall). In other examples, the box has a relatively short height and greater depth so that one or more folded towels can be positioned within the cavity. In at least one example, a medicine cabinet may be formed in or attached to the back side of the cavity, such as be arranged and accessible from another part of the bathroom positioned adjacent to the shower or bathtub area.

In some examples, the towel warming device includes a heating assembly that is inserted into the cavity of the housing. The heating assembly may include, for example, a molded plastic insert having one or more heating elements molded into the walls of the insert. The heating elements may include, for example, resistive heating elements, and the heating elements are connected to an AC power supply of the building structure within which the towel warming device is positioned. Many other heating assembly configurations are possible, including configurations that include one or more heating elements that are positioned in or mounted to internal or external walls of the housing.

Generally, the heating assembly provides a source of heat that warms a towel or other device that is positioned within the cavity of the housing. The heating element may be in direct contact with the towel. Alternatively, the heating element may simply increase the internal temperature of the cavity, thereby providing indirect heating of the towel.

The heating element may be coupled to a control device used to turn the heating element on and off. The control device may be coupled to the heating element with a wired connection, or may be coupled wirelessly to the heating element. The controller may be electrically coupled to other components such as, for example, one or more temperature sensors, motion sensors, door closure sensors, or sensors that detect, for example, turning on or off the water supply to the shower and/or bathtub, opening or closing the door or the shower curtain, opening or closing the door that provides access to the cavity of the housing, or one or more towels within the cavity. The controller may receive input from a variety of sensors that may be possible and use that sensor data to determine automatically, or in response to user input, steps to operate the heating element or other functions of the towel warming device. The controller may be housed within the housing of the towel warming device. Alternatively, the controller may be positioned remote from the housing such as, for example, on a different wall or area of the bathroom within which the shower or bathtub area is located.

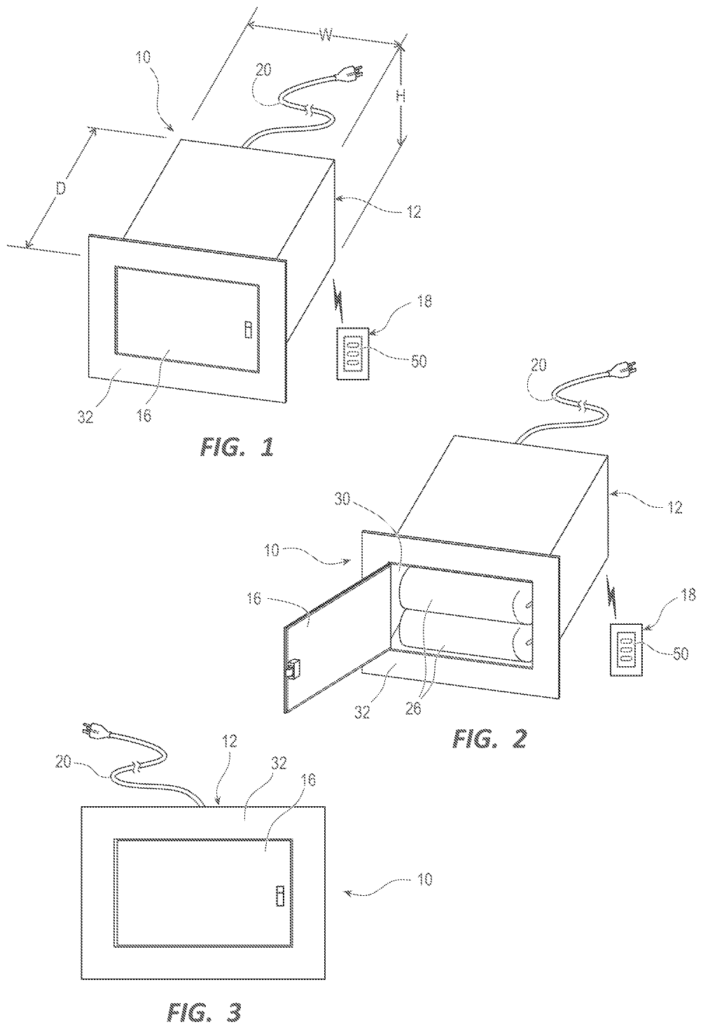

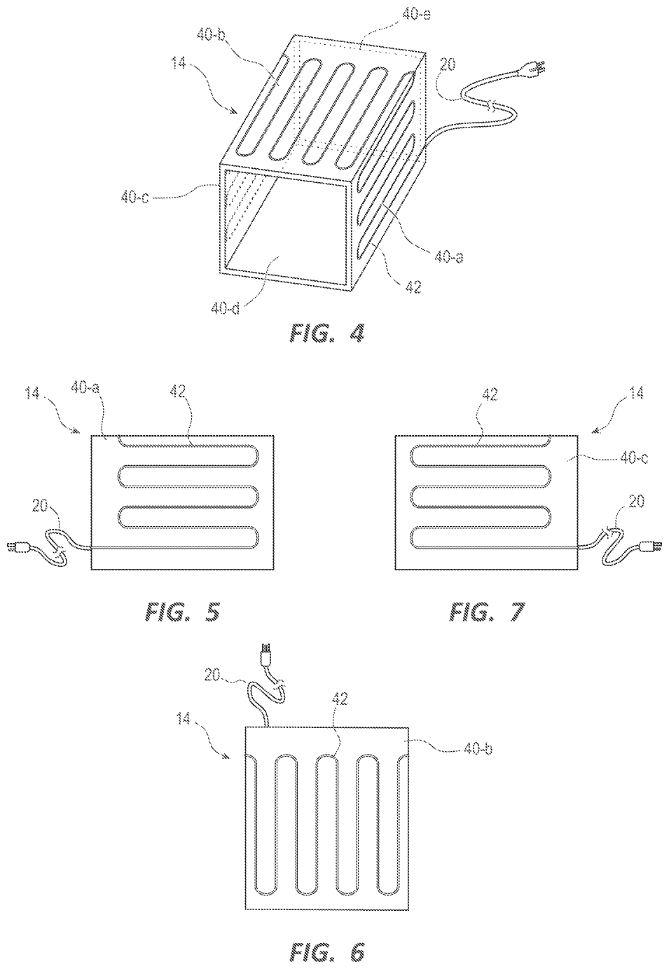

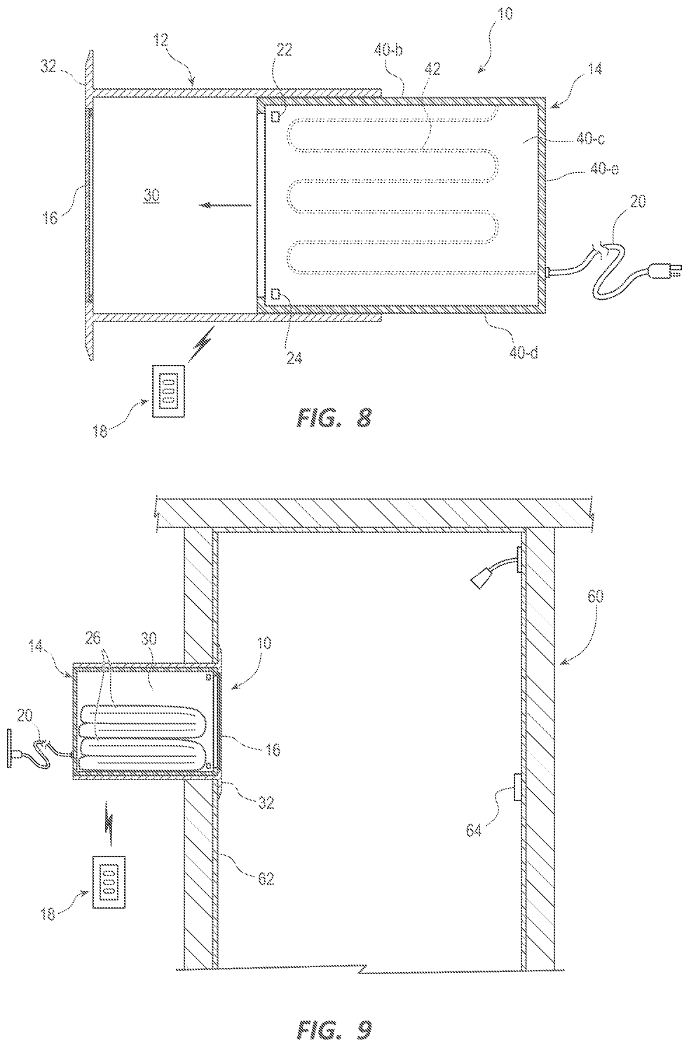

Referring now to FIG. 1, an example towel warming device 10 is shown and described. The towel warming device 10 includes a housing 12, a heating assembly 14 (shown in FIGS. 4-9), a door 16, a controller 18, a power source or wire 20, a temperature sensor 22 (see FIG. 8), and a light source 24 (see FIG. 8). FIG. 2 shows the towel warming device 10 with the door 16 in an open position and a plurality of towels 26 positioned in a cavity 30 of the housing 12. FIG. 3 shows the door 16 on a front view of the towel warming device 10. The housing 12 may also include a bezel 32 that provides an improved interface (e.g., a watertight interface) with the wall of the shower or bathtub and/or with the internal cavity 30 of the housing 12, as shown in FIG. 9. The housing 12 may have a width W and a height H as shown in FIG. 1. In at least one example, the width W is about 14.5 inches or less to facilitate positioning between standard wall studs that are typically spaced apart by about 16 inches on center. The height H may be in the range of about 8 inches to about 36 inches, and may be dependent on, for example, the width W and a depth D of the housing (also shown in FIG. 1). The depth D typically is in the range of about 3.5 inches (the standard wall thickness when using a 2×4 stud) to about 18 inches, and more particularly about 10 inches to about 15 inches. Typically, the cavity 30 has a volume of about 0.5 cubic feet to about 2 cubic feet, and more particularly about 1 cubic foot.

The towel warming device 10 may include a heating assembly having various configurations, any of which may provide increased temperatures within the housing 12 to heat the towels 26 positioned therein. Referring to FIGS. 4-8, an example heating assembly 14 is shown including a plurality of panels 40a-e that together define a module that can be inserted within the cavity 30 of the housing 12. One or more of the panels 40a-e may include a heating element 42. In one example, the heating elements 42 are resistive heating devices that generate heat when power is supplied to the heating element 42. Various other types of heating elements are possible. Typically, the heating elements 42 are connected to a power supply such as, for example, the power line or wire 20. The wire 20 may have a plug at a free end thereof to releasably connect to another source of power such as an AC wall plug.

The panels 40a-e may be individually formed and secured together to form the module shown in FIG. 4. Alternatively, the panels 40a-e may be molded together as a single, unitary part. The heating elements 42 may be mounted to one or more surfaces of the panels 40a-e. Alternatively, one or more of the heating elements 42 may be molded into one or more of the panels 40a-e. In some examples, one or more of the heating elements 42 are exposed for contact with items positioned within the cavity 30, such as the towels 26. Alternatively, the heating elements 42 are spaced away from the towels 26 and heat is radiated through the panels 40a-e into the towels 26 or into the cavity 30 wherein the towels 26 are indirectly heated by the warm air contained in the cavity 30.

The heating assembly 14 may be removably mounted within the cavity 30 of the housing 12. FIG. 8 shows the heating assembly 14 being inserted into the cavity 30 from a rear end of the housing 12. The heating assembly 14 (i.e., the panel 40e) may define a rear wall of the towel warming device 10. Alternatively, the housing 12 may include a separate rear wall that is openable to receive the heating assembly 14 into the cavity 30 and then closed upon insertion of the heating assembly 14. In at least some examples, the heating assembly 14 does not include a rear panel 40e.

In other examples, one or more of the panels 40a-e may be individually mounted to one or more internal or external surfaces of the housing 12. In still further examples, the panels 40a-e define the housing and/or replaced portions of the housing 12. The panels 40a-e may provide insulative as well as structural functionality for the towel warming device 10.

The door 16 may be mounted to the housing 12 with one or more hinges or other fastening devices. In at least one example, the door 16 includes a handle for opening and closing the door 16. The door 16 may be held in a closed position (shown in FIG. 1) using a releasable fastener such as, for example, a magnet attachment, bracket, latch, or the like. In some examples, the door 16 comprises a transparent material such as a transparent plastic such as plexiglass, tempered glass, or the like. In other examples, the door 16 comprises a translucent material or an opaque material. Preferably, the door 16, as with other features of the towel warming device 10, is comprised of materials that are resistant to wear, corrosion, or material degradation as a result of being exposed to water and cleaning products that are typically present within a shower or tub area.

The door 16 interfaces with the bezel 32 in a way that provides a watertight connection that prevents water from entering the cavity 30. In at least some examples, the bezel 32 includes a recessed seat or other sealing interface to provide the watertight seal. The seal may be provided by a separate sealing member, gasket, or the like.

Providing the door with a transparent material may be advantageous for at least the reason that the user can easily assess whether a towel is available within the cavity 30 without having to open the door 16. The towel warming device 10 may include the light source 24 to provide further assistance in determining whether a towel is present or how many towels are positioned within the cavity 30. Alternatively, a user interface (e.g., a screen or display), a light, or audible message may provide an indication to the user about the presence of a towel within the cavity 30 and/or the readiness for use of the towel (e.g., based on a temperature of the towel itself, the temperature of the cavity 30, and/or an amount of time which the heating assembly 14 has been activated).

The controller 18 is shown as a separate device from the housing 12 and heating assembly 14. Alternatively, the controller 18 may be mounted directly to or integrated into the housing 12 and/or heating assembly 14. In one example, the controller 18 includes a user interface 50 with one or more user-selectable buttons or portions of a screen for selection of one or more options.

The controller 18 may be positioned on a wall of the bathroom at a location remote from the housing 12. In one example, the controller 18 is mounted on a wall of the shower adjacent to the shower door or entrance into the bathtub area of the bathroom. The controller 18 may include, at a minimum, an on/off switch to turn on the heating assembly 14. In some examples, the controller 18 includes a processor, memory, and other computer components that provide additional functionality beyond on/off control of the heating assembly 14. For example, the controller 18 may be capable of receiving input from one or more sensors (e.g., temperature sensor 22 shown in FIG. 8) and automatically turn the heating assembly 14 off when a certain threshold temperature is reached (e.g., 120 degrees Fahrenheit). The controller 18 may include a timer, and may be operable to automatically shut off the heating assembly 14 after a certain amount of time has elapsed (e.g., 4 minutes, or other predetermined time period associated with a typical amount of time to take a shower or bath).

The towel warming device 10 may include a plurality of other sensors such as, for example, the sensor 64 positioned in or associated with a shower 60, as shown in FIG. 9. The sensor 64 may detect, for example, opening or closing of a shower door or curtain, motion within the shower 60, a temperature outside of the shower (e.g., used to determine a temperature differential between inside the shower and outside the shower) or other conditions associated with the user, the shower, or the towel warming device 10 itself. The controller 18 may receive input from the one or more sensors and provide automated control, user feedback, control options for the user to select among, warnings or messages for the user, or the like in response to the information received from or determined as a result of the feedback from the sensors. The controller 18 generally may operate in response to one or more user inputs such as, for example, automatically turning on the heating assembly 14 at a certain time of day, operating the heating assembly 14 for a certain amount of time, turning on and off lighting or other features of the towel warming device 10, or the like.

In at least some examples, the controller 18 is in wireless communication with the heating assembly 14 and other features of the towel warming device 10 such as, for example, the temperature sensor 22, the light source 24, or the sensor 64. Wired connections are also possible.

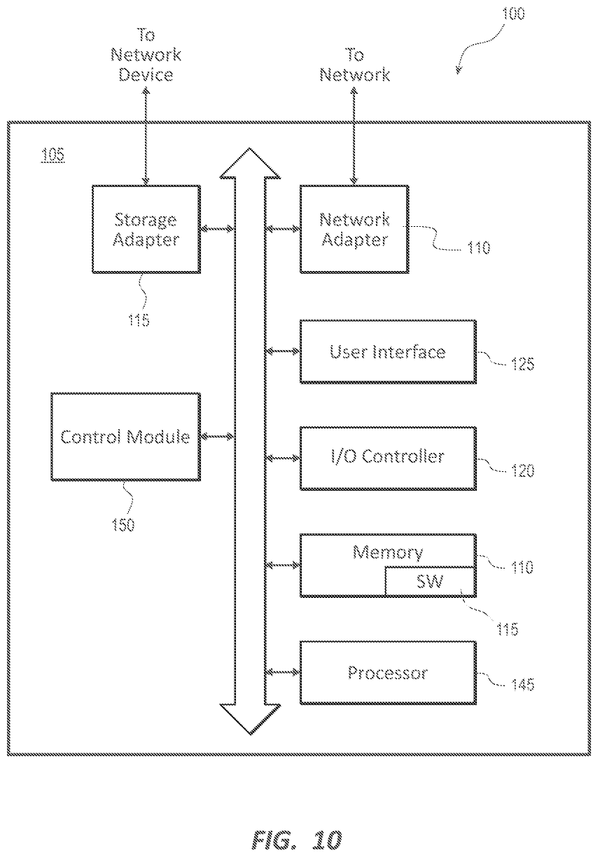

FIG. 10 shows a diagram of a system 100 including a device 105 that supports a shield device in accordance with aspects of the present disclosure. The device 105 may be an example of or include the components of any of the towel warming devices described herein. The device 105 may include components for data communications including components for transmitting and receiving communications, including a control module 150, a storage adapter 110, an I/O controller 115, a transceiver 120, a user interface 125, memory 130, and a processor 140. These components may be in electronic communication via one or more buses (e.g., bus 145).

The control module 150 may provide control of one or more aspects of the shield devices disclosed herein. For example, the control module may receive user inputs, process instructions, communicate data to a user, display content, and the like. Some of the operations facilitated by control module 150 may conducted automatically in response to stored instructions, code, or algorithms. The control module 150 may communicate wirelessly with a server via a network, wherein data transferred via the network is stored in one or more databases. Aspects of the control module 150 may operate on site, such as being integral with one or more operational features of the shield devices disclosed herein. In other examples, aspects of the control module 150 are stored and/or operational using a local or remotely located service or network, or stored and/or operation using the remotely stored database.

The I/O controller 115 may manage input and output signals for the device 105. The I/O controller 115 may also manage peripherals not integrated into the device 105. In some cases, the I/O controller 115 may represent a physical connection or port to an external peripheral. In some cases, the I/O controller 115 may utilize an operating system such as iOS®, ANDROID®, MS-DOS®, MS-WINDOWS®, OS/2®, UNIX®, LINUX®, or another known operating system. In other cases, the I/O controller 115 may represent or interact with a modem, a keyboard, a mouse, a touchscreen, or a similar device. In some cases, the I/O controller 115 may be implemented as part of a processor. In some cases, a user may interact with the device 105 via the I/O controller 115 or via hardware components controlled by the I/O controller 115.

The transceiver 120 may communicate bi-directionally, via one or more antennas, wired, or wireless links as described herein. For example, the transceiver 120 may represent a wireless transceiver and may communicate bi-directionally with another wireless transceiver. The transceiver 120 may also include a modem to modulate the packets and provide the modulated packets to the antennas for transmission, and to demodulate packets received from the antennas.

The memory 130 may include RAM and ROM. The memory 130 may store computer-readable, computer-executable code 135 including instructions that, when executed, cause the processor to perform various functions described herein. In some cases, the memory 130 may contain, among other things, a BIOS which may control basic hardware or software operation such as the interaction with peripheral components or devices.

The processor 140 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 140 may be configured to operate a memory array using a memory controller. In other cases, a memory controller may be integrated into the processor 140. The processor 140 may be configured to execute computer-readable instructions stored in a memory (e.g., the memory 130) to cause the device 105 to perform various functions (e.g., functions or tasks supporting a shield device).

The code 135 may include instructions to implement aspects of the present disclosure, including instructions to support a shield device. The code 135 may be stored in a non-transitory computer-readable medium such as system memory or other type of memory. In some cases, the code 135 may not be directly executable by the processor 140 but may cause a computer (e.g., when compiled and executed) to perform functions described herein.

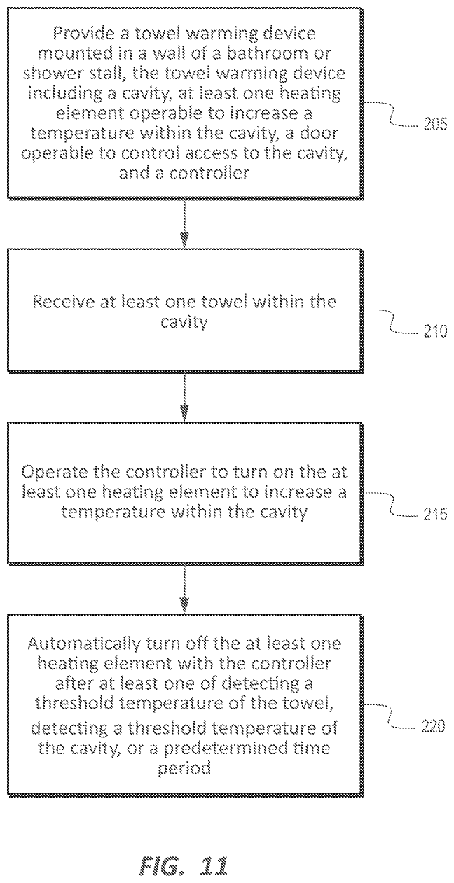

Referring now to FIG. 11, an example method 200 of providing a warmed towel is described. The method 200 may be one example of operating and/or implementing at least some of the functionality associated with the towel warming device 10 or system 100 described above with reference to FIGS. 1-10.

The method 200 includes, at block 205, providing a towel warming device mounted in a wall of a bathroom or shower stall, the towel warming device including a cavity, at least one heating element operable to increase a temperature within the cavity, a door operable to control access to the cavity, and a controller. At block 210, the method 200 includes receiving at least one towel within the cavity. Block 215 includes operating the controller to turn on the at least one heating element to increase a temperature within the cavity. Block 220 includes automatically turning off the at least one heating element with the controller after at least one of detecting a threshold temperature of the towel, detecting a threshold temperature of the cavity, or a predetermined time period.

The method 200 may further include illuminating the cavity with at least one light generating device. The method 200 may include receiving at least one user input at a user interface, the at least one user input providing operation of the controller. The method 200 may include detecting at least one of shower door operation or a shower faucet operation, and operating the controller based on the detecting. The method 200 may include detecting the door in a closed position prior to operating the controller to turn on the at least one heating element. The method may include wirelessly controlling the at least one heating element.

The towel warming devices disclosed herein may provide many advantages including at least the following:
Provide warm, dry towels within a shower and/or bathtub area of a bathroom for use by a user upon completion of the shower/bath without having to open the door and/or pull open the shower curtain.
Provide automated on/off control of the heating assembly used to warm the towel within the towel warming device.
Provide visibility of the interior of the towel warming device for easy detection by the user of the available towels.
Improved maintenance for the heating assembly by providing for easy replacement of the heating assembly or various heating elements and/or panels in the heating assembly in the event of malfunction.
Remote control of the heating assembly so as to provide electronic components remote from the water source while the user is exposed to water in the shower or bathtub area.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.”

What is claimed is:

1. A towel warming device for use in a bathroom or shower stall, the device comprising:
a housing defining a cavity, the housing configured to be mounted in a wall of the bathroom or shower stall, the cavity being sized to store at least one towel;
at least one heating element operable to increase a temperature within the cavity to warm the at least one towel;
a door operable to control access to the cavity;
a temperature control device operable to control the at least one heating element.

2. The towel warming device of claim 1, wherein the cavity is sized to store at least two towels.

3. The towel warming device of claim 1, wherein the at least one heating element includes separate heating elements positioned at on at least two walls of the housing that define the cavity.

4. The towel warming device of claim 1, wherein the at least one heating element includes a module configured to be removably mounted in the cavity.

5. The towel warming device of claim 4, wherein the module includes at least four walls.

6. The towel warming device of claim 5, wherein each of the at least four walls includes a portion of a resistive heating member.

7. The towel warming device of claim 1, wherein the at least one heating element is powered with AC power and is configured to be wired to electrical wiring of the bathroom or building that houses the shower stall.

8. The towel warming device of claim 1, wherein the temperature control device is wirelessly connected to the at least one heating element.

9. The towel warming device of claim 1, further comprising at least one temperature sensor to detect the temperature within the cavity.

10. The towel warming device of claim 1, wherein the temperature control device includes a user interface at least one user selectable option for controlling one or more functions of the towel warming device.

11. The towel warming device of claim 1, further comprising a light source operable to provide light within the cavity.

12. The towel warming device of claim 1, wherein the door includes a transparent portion.

13. The towel warming device of claim 1, wherein the housing includes a flexible bezel configured to provide a water-tight connection between the housing and the wall.

14. The towel warming device of claim 1, further comprising one or more sensors to generate a sensor signal in response to detecting at least one of opening a door of the shower stall or turning on a shower faucet, the temperature control device being operable to turn on the at least one heating element in response to the sensor signal.

15. A method of warming a towel, comprising:
providing a towel warming device mounted in a wall of a bathroom or shower stall, the towel warming device including a cavity, at least one heating element operable to increase a temperature within the cavity, a door operable to control access to the cavity, and a controller;
receiving at least one towel within the cavity;
operating the controller to turn on the at least one heating element to increase a temperature within the cavity;
automatically turning off the at least one heating element with the controller after at least one of detecting a threshold temperature of the towel, detecting a threshold temperature of the cavity, or a predetermined time period.

16. The method of claim 15, further comprising illuminating the cavity with at least one light generating device.

17. The method of claim 15, further comprising receiving at least one user input at a user interface, the at least one user input providing operation of the controller.

18. The method of claim 15, further comprising detecting at least one of shower door operation or a shower faucet operation, and operating the controller based on the detecting.

19. The method of claim 15, further comprising detecting the door in a closed position prior to operating the controller to turn on the at least one heating element.

20. The method of claim 15, further comprising wirelessly controlling the at least one heating element.
